(19) United States
(12) Patent Application Publication
(10) Pub. No.: US 2015/0289158 A1
(43) Pub. Date: Oct. 8, 2015

(54) SYSTEM AND METHOD FOR BALANCING DATA TRAFFIC LOAD OF MOBILE COMMUNICATION DEVICE HAVING MULTIPLE INTERFACES

(71) Applicant: ELECTRONICS AND TELECOMMUNICATIONS RESEARCH INSTITUTE, Daejeon (KR)

(72) Inventors: Jae Chan SHIM, Daejeon (KR); Pyung Koo PARK, Daejeon (KR); Ho Yong RYU, Daejeon (KR)

(21) Appl. No.: 14/666,529

(22) Filed: Mar. 24, 2015

(30) Foreign Application Priority Data
Apr. 3, 2014 (KR) 10-2014-0040172

(51) Int. Cl. H04W 28/02; H04W 24/04; H04W 28/08

(52) U.S. Cl. CPC H04W 28/0215; H04W 28/08; H04W 28/0236; H04W 24/04; H04W 28/0226

(57) ABSTRACT

A system for balancing a data traffic load of a mobile communication device having multiple interfaces includes: an interface state management unit monitoring whether a failure occurs in a plurality of wireless interfaces included in a mobile communication apparatus; an interface quality management unit calculating load balancing ratios to be set for the plurality of wireless interfaces, respectively based on information on the plurality of wireless interfaces; and an interface control unit distributing data traffics to the plurality of respective wireless interfaces based, on the load balancing ratios.

This application claims the benefit of priority of Korean Patent Application No. 10-2014-0040172 filed on Apr. 3, 2014, which is incorporated by reference in its entirety herein.

### BACKGROUND OF THE INVENTION

b 1. Field of the Invention

Embodiments of the present invention relate to a system and a method for balancing a data traffic load for maximizing data transmission efficiency in providing a mobility service based on a tunnel in a mobile communication apparatus having various wireless interfaces such as Wireless Fidelity (WiFi), 2 Generation (2G), 3G, Worldwide interoperability for Microwave Access (WiMax), long term evolution (LTE), and the like.

2. Discussion of the Related Art

Recently, various access networks including Wireless Fidelity (WiFi), 2 Generation (2G), 3G, Worldwide interoperability for Microwave Access (WiMax), long term evolution (LTE), and the like have been serviced and a mobile communication apparatus has had a plurality of wireless interfaces in order to access the various access networks. Herein, the mobile communication apparatus includes personal portable terminals including a smart phone, a smart pad, a notebook computer, and the like, a mobile router installed in moving means including a bus, a train, an automobile, and the like, and the like and all mobile communication apparatuses supports a mobility service based on a tunnel.

As one example, Korean Patent Laid-open No. 10-2009-0065322 (publication date: Jun. 22, 2009), “Method for supporting mobility using secure tunnel” discloses providing mobility to a terminal through configuring an active tunnel and a standby tunnel with respect to movement of the terminal in an internal network and movement of the terminal to an external network and securing stability of a network by using a secure access.

A plurality of tunnels (the active tunnel and the standby tunnel) are configured in the wireless interface of the mobile communication apparatus I order to provide the mobility as described above, but since data is transmitted through only an active interface, the mobile communication apparatus shared by various users, such as a mobile router is low in network usage efficiency. Accordingly, a method that can improve data transmission efficiency by simultaneously using multiple interfaces included in the mobile communication apparatus is required.

### SUMMARY OF THE INVENTION

An object of the present invention is to provide a system and a method for balancing a data traffic load of a mobile communication apparatus having multiple interfaces, which can improve data transmission efficiency by distributing traffics by considering states and qualities of all interfaces in supporting mobility through multiple interfaces under a tunnel based mobility supporting service environment using the mobile communication apparatus and a mobility integration control server.

Another object of the present invention is to provide a system and a method for balancing a data traffic load of a mobile communication apparatus having multiple interfaces, which can increase operation efficiency of an interface by distributing data traffics by dynamically measuring states and qualities of the multiple interfaces while ensuring mobility.

In accordance with an embodiment of the present invention, a system for balancing a data traffic load includes; art interface state management unit monitoring whether a failure occurs in a plurality of wireless interfaces included in a mobile communication apparatus; an interface quality management unit calculating load balancing ratios to be set for the plurality of wireless interfaces, respectively based on information on the plurality of wireless interfaces; and an interface control unit distributing data traffics to the plurality of respective wireless interfaces based on the load balancing ratios.

The information on the wireless interface may include received signal strength information of each wireless interface, round trip time (RTT) information with a mobility integration control server for each wireless interface, bandwidth information of each wireless interface, positional information of base stations corresponding to the plurality of wireless interfaces, respectively, moving direction information of the mobile communication apparatus, and moving speed information of the mobile communication apparatus.

The interface quality management unit may calculate transmission quality values of the plurality of respective wireless interfaces based on a received signal strength value of each wireless interface, an RTT value with the mobility integration control server for each wireless interface, a relative bandwidth value of each wireless interfaced to a wireless interface having a maximum bandwidth, and a movement direction value and a moving speed value of the mobile communication apparatus for the corresponding base station for each wireless interface, and calculate the load balancing ratios to be set for the plurality of wireless interfaces, respectively based on the calculated transmission quality values.

The system may further include a load balancing policy management unit selecting a load balancing mode to be performed between a static mode in which the data traffics are distributed to the plurality of wireless interfaces, respectively according to predetermined load balancing ratios and a dynamic mode in which the data traffics are distributed to the plurality of wireless interfaces, respectively according, to the load balancing ratios calculated based on the information on the operation state and managing the number of wireless interfaces used for load balancing.

The interface quality management unit may exclude, when a failure is sensed in at least one wireless interface among the plurality of wireless interfaces, the corresponding, wireless interface from data transmission and calculate the load balancing ratios to be set for the residual wireless interfaces, respectively.

The interface quality management unit may make, when a preparatory wireless interface is present among the plurality of wireless interfaces, the corresponding preparatory wireless interface to be included at the time of recalculating the load balancing ratios.

The interface quality management unit may make, when a normal operation of the wireless interface having the failure is sensed afterward, the corresponding wireless interface to be included and exclude the preparatory wireless interface.

In accordance with another embodiment of the present invention, a method system for balancing a data traffic load by a system for balancing a data traffic load includes: monitoring whether a failure occurs in a plurality of wireless interfaces included in a mobile communication apparatus; calculating load balancing ratios to be set for the plurality of wireless interfaces, respectively based on information on the plurality of wireless interfaces; and distributing data traffics to the plurality of respective wireless interfaces based on the load balancing ratios.

In accordance with yet another embodiment of the present invention, a mobile communication apparatus includes: at least one processor; and a memory storing at least one program, wherein the program is configured to be executed by at least one processor, monitors whether a failure occurs in a plurality of wireless interfaces included in a mobile communication apparatus, calculates load balancing ratios to be set for the plurality of wireless interfaces, respectively based on information on the plurality of wireless interfaces; and distributes data traffics to the plurality of respective wireless interfaces based on the load balancing ratios.

State and communication qualities among multiple interfaces are measured, and as a result, loads for data transmission are distributed to respective interfaces to improve data transmission efficiency and improve network usage efficiency. In particular, under an environment in which a lot of users share a network like mobile routers installed in vehicle, trains, ships, and airplanes, stability of a service and user satisfaction can be improved through load balancing for data.

### BRIEF DESCRIPTION OF THE DRAWINGS

FIG. 1 is a diagram for describing a tunnel based mobility supporting service.

FIG. 2 is a block diagram illustrating a system for balancing a data traffic load according to an exemplary embodiment of the present invention.

FIG. 3 is a flowchart illustrating a general operation process of the system for balancing a data traffic load according to an exemplary embodiment of the present invention.

FIG. 4 is a flowchart illustrating an operation process of the system for balancing a data traffic load when a failure occurs in a specific wireless interface according to an exemplary embodiment of the present invention.

FIG. 5 is a flowchart illustrating an operation process of the system for balancing a data traffic load when the wireless interface having the failure is restored to a normal state according to the exemplary embodiment of the present invention.

FIG. 6 is a block diagram illustrating a mobile communication apparatus according to an exemplary embodiment of the present invention.

### DETAILED DESCRIPTION OF THE EMBODIMENTS

The, present invention will be described more fully hereinafter with reference to the accompanying drawings, in which embodiments of the invention are shown. However, the present invention can be realized in various different forms, and is not limited to the embodiments described herein. Accordingly, the drawings and description are to be regarded as illustrative in nature and not restrictive. Like reference numerals designate like elements throughout the specification.

In the specification, unless explicitly described to the contrary, the word “comprise” and variations such as “comprises” or “comprising”, will be understood to imply the inclusion of stated elements but not the exclusion of any other elements. Further, terms including “unit” disclosed in the specification mean a unit that processes at least one function or operation and this may be implemented by hardware or software or a combination of hardware and software.

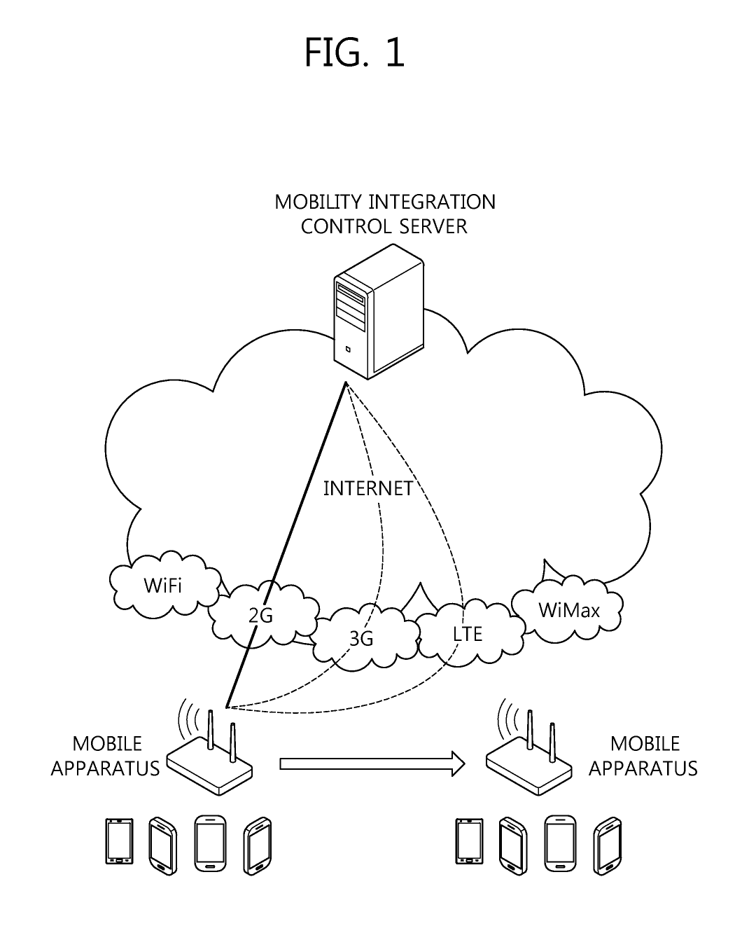

FIG. 1 is a diagram for describing a tunnel based mobility supporting service.

A user may access the Internet through various access networks including Wireless Fidelity (WiFi), 2 Generation (2G), 3G Worldwide interoperability for Microwave Access (WiMax), long term evolution (LTE), and the like. In this case, mobility is supported to a mobile communication apparatus based on a tunnel. Herein, the mobile communication apparatus includes personal portable terminals including a smart phone, a smart pad, a notebook computer, and the like, a mobile router installed in moving means including a bus, a train, an automobile, and the like, and the like and has multiple interfaces so as to access various wireless access networks. Herein, the personal portable terminal and the mobile router have the multiple interfaces in common, but are different from each other in that the mobile router may accommodate a plurality of personal users. In this case, the users generally access the mobile router through the WiFi.

The mobile communication apparatus authenticates network access through a wireless access network and when the authentication is completed, the mobile communication apparatus receives an IP address to configure a mobility integration control server and an active tunnel. In general, the active tunnel is configured through an interface having the highest quality at present among the wireless interfaces. Further, the mobile communication apparatus configures a standby tunnel in another interface in order to support mobility. As one example, in FIG. 1, the active tunnel is configured through the 2G interface and the standby tunnel is configured through the 3G interface and the LTE interface. In this case, user data is transmitted through the active tunnel and not transmitted through the standby tunnel.

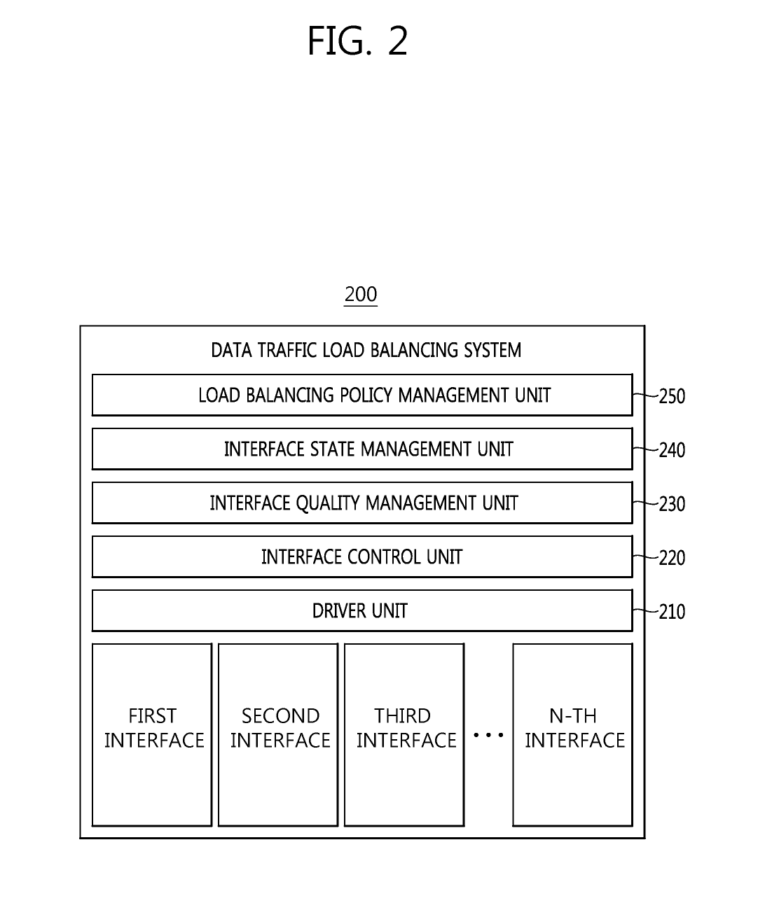

FIG. 2 is a block diagram illustrating a system for balancing a data traffic load according to an exemplary embodiment of the present invention.

Referring to FIG. 2, the traffic load balancing control system 200 includes a driver unit 210, an interface control unit 220, an interface quality management unit 230, an interface state management unit 240, and a load balancing policy management unit 250 and includes physical interfaces (first to n-th interfaces) corresponding to various wireless communication technologies WiFi, 2G, 3G, LTE, WiMax, and the like, respectively.

The driver unit 210 controls initialization and a function operation of the interface for smoothly operating the corresponding interface.

The interface control unit 220 distributes data traffics to the respective wireless interfaces according to data distribution ratios of the respective wireless interfaces based on load balancing ratio information calculated by the interface quality management unit 230.

The interface quality management unit 230 calculates a load balancing ratio set in each interface based on information on the wireless interface and if a state change of the interface is sensed, the interface quality management unit calculates the load balancing ratio in real time and when there is no state change, the interface quality management unit 230 cyclically the calculates the load balancing ratio.

The interface state management unit 240 monitors a physical operation state of each wireless interface, that is, whether a state of each wireless interface is changed (for example, whether the failure occurs), and when the state change in a specific wireless interface is sensed, the interface state management unit 240 notifies the sensed state change to the interface quality management unit 230 to exclude the corresponding wireless interface from data transmission. Further, the interface state management unit 240 acquires information on each wireless interface, that is, a factor value required to calculate the load balancing ratio and transfers the acquired factor value to the interface quality management unit 230. In this case, when the state change of the interface is sensed, the factor value is acquired in real time and when there is no state change, the factor value is cyclically acquired.

As one example, when the interface quality management unit 230 receives from the interface state management unit 240 a notification that the specific wireless interface is excluded from the data transmission, load balancing ratios to be set in residual wireless interfaces other than the corresponding wireless interface may be recalculated.

The load balancing policy management unit 250 performs load balancing mode management and load balancing policy management. Herein, the load balancing mode management is a function to control a load balancing function so, as to operate in a static mode or a dynamic mode and when the load balancing function is set in the state mode, the data traffics are distributed according to a load balancing ratio previously manually set for each interface by an operator. If the load balancing function is set in the dynamic mode, a distribution ratio of data is determined for each wireless interface according to interface quality, that is, the load balancing ratio calculated in real time and the data traffics are distributed to the respective interfaces according to the load balancing ratio.

Meanwhile, the load balancing policy management is to manage a policy for controlling the number of interfaces used for load balancing of the data traffics and for example, when it is assumed that 10 different wireless interfaces are provided, the traffics are primarily distributed by using all of 10 wireless interfaces, but when it is determined that only 8 wireless interfaces are used and 2 wireless interfaces are preparatory according to the load balancing policy, the load balancing ratio is calculated for only 8 wireless interfaces and the data traffics are distributed to each wireless interface according to the ratio. In this case, data is not transmitted through 2 residual wireless interfaces determined to be preparatory. When the preparatory wireless interface is present as described above, the interface quality management unit 230 may make the preparatory wireless interface to be included at the time of recalculating the load balancing ratio due to the failure which occurs in the specific wireless interface and when it is sensed that the failure in the specific wireless interface is restored, and as a result, the specific wireless interface normally operates, the interface quality management unit 230 may make the corresponding wireless interface to be included at the time of calculating the load balancing ratio again and exclude the preparatory wireless interface.

Meanwhile, the interface quality management unit 230 verifies the load balancing policy and thereafter, determines the load balancing ratio for each wireless interface used for the data transmission when the load balancing mode is in the dynamic mode and information on the wireless interface used in this case is described below.

1. Received signal strength (RSS) information of each wireless interface. Since the RSS information is changed depending on a kind and a type of the wireless interface, the interface quality management unit 230 may convert a received signal strength into a percentage and use the RSS.

2. Actual round trip time (RTT) information with the mobile integration control server for each wireless interface. The RTT as a time value and a relative value for an interface which is highest in the RRT value may be applied to each wireless interface.

3. Bandwidth information of each wireless interface. The interface quality management unit 230 may recalculate the load balancing ratio by using a relative bandwidth (RB) value of each wireless interface to a wireless interface having a maximum bandwidth.

4. Geographical positional information of a base station corresponding to each wireless interface and movement direction (MD) information of a mobile communication apparatus. The interface quality management unit 230 may calculate the MD value of the mobile communication apparatus for the corresponding base station for each wireless interface based on the geographical positional information of the base station and the MD information of the mobile communication apparatus. This is a relative value depending on the case where the mobile communication apparatus is close to the base station and the case where the mobile communication apparatus is distant from the base station.

5. Moving speed (MS) information of the mobile communication apparatus. This is a relative value to a moving speed of the mobile communication apparatus.

The interface quality management unit 230 calculates a transmission quality value for each wireless interface by using the information on the wireless interface and the transmission quality value may be expressed as Equation 1 given below as one example.

$$Qi = ( RSS + \frac{1}{RTT} ) * RB * MD * MS \qquad [ Equation 1 ]$$

Where, Qi represents a transmission quality value of an i-th wireless interface.

When the transmission quality value of each wireless interface calculated through Equation 1 is converted into the percentage, the corresponding percentage becomes the load balancing ratio of each wireless interface and the interface control unit 220 distributes the data traffics to each wireless interface according to the load balancing ratio. The interface quality management unit 230 may calculate the load balancing ratio cyclically or in real time and a calculation cycle may be variably determined according to an operating environment, for example, a network condition.

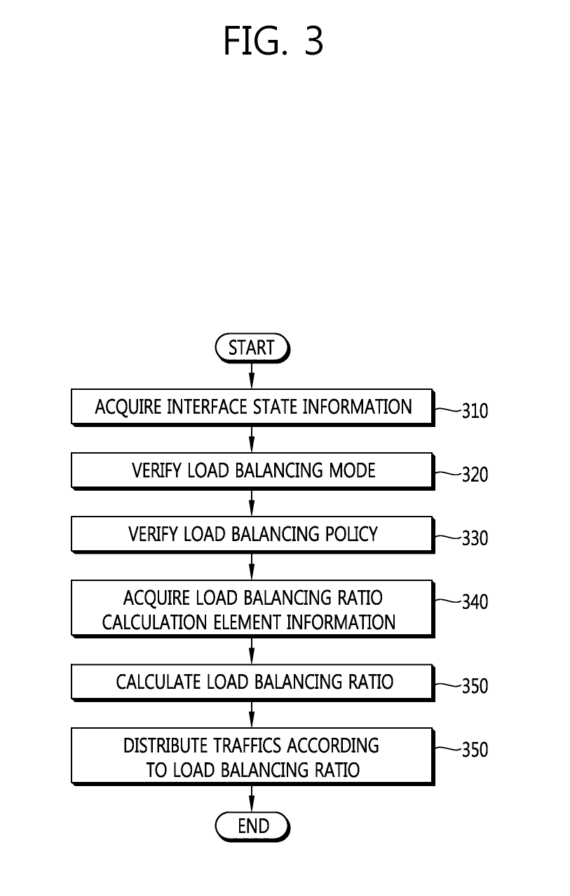

FIG. 3 is a flowchart illustrating a general operation process of the system for balancing a data traffic load according to an exemplary embodiment of the present invention.

Referring to FIG. 3, when the data traffic load balancing system according to the present invention generally operates, the interface state management unit 240 monitors an operation state of each wireless interface to acquire state information of each interface (310) and transfer the acquired state information to the interface quality management unit 230. The interface quality management unit 230 verifies the load balancing mode and the load balancing policy (that is, the number of wireless interfaces used for load balancing) (320 and 330). As a result of the verification, when the load balancing mode is a dynamic mode and a wireless interface to be used for data transmission is verified, the interface quality management unit 230 acquires from the interface state management unit 240 load balancing ratio calculation element information including the RSS information, the RTT information, and the bandwidth information for the corresponding wireless interface, the positional information of the base station, the MD information and the. MS information of the mobile communication apparatus, and the like (340). In addition, the load balancing ratio is calculated for each wireless interface based on the information (350) and transferred to the interface control unit 220. Then, the interface control unit 220 distributes the data traffics to the corresponding wireless interface according to the received load balancing ratio (360).

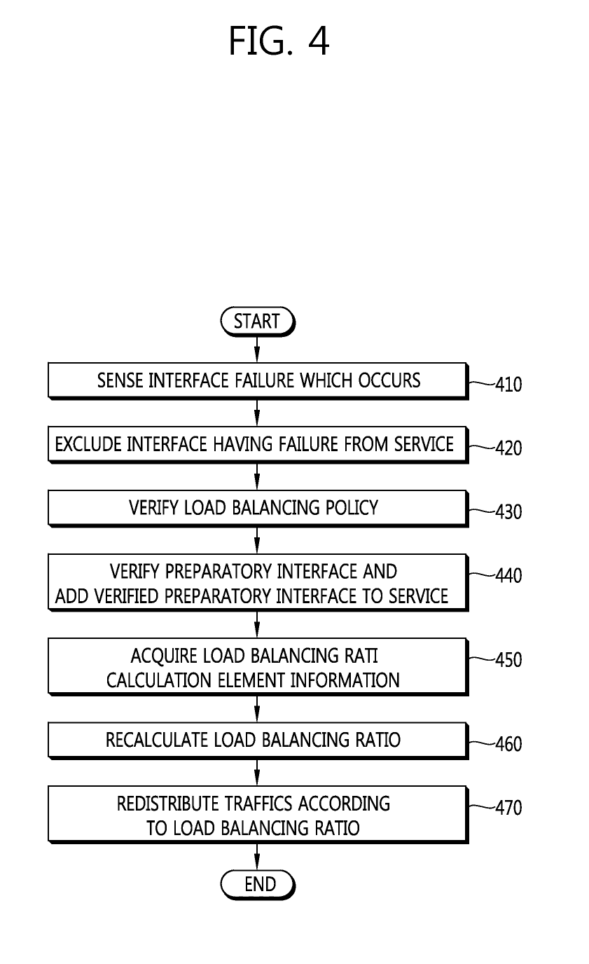

FIG. 4 is a flowchart illustrating an operation process of the system for balancing a data traffic load when a failure occurs in a specific wireless interface according to an exemplary embodiment of the present invention.

Referring to FIG. 4, when the interface state management unit 240 senses a failure which occurs in a specific wireless interface (410), the interface state management unit 240 notifies information on the corresponding wireless interface to the interface quality management unit 230. The interface quality management unit 230 that receives the notification immediately excludes the interface having the failure from data transmission (420). In addition, when it is verified that a preparatory interface is present by verifying the load balancing policy (430), the preparatory interface is added to a service (440) to acquire load balancing ratio calculation element information for residual normal interfaces including the preparatory interface from the interface state management unit 240 (450) and thereafter, recalculate the load balancing ratio based on the acquired load balancing ratio calculation element information (460) and transfer the recalculated load balancing ratio to the interface control unit 220. In this case, if all interfaces are used for the data transmission, the interface quality management unit 230 recalculates the load balancing ratios for the residual interfaces other than the interface having the failure and transfers the recalculated load balancing ratio to the interface control unit 220. Then, the interface control unit 220 redistributes the data traffics transferred through the interface having the failure to the normal interfaces according to a newly set load balancing ratio (470).

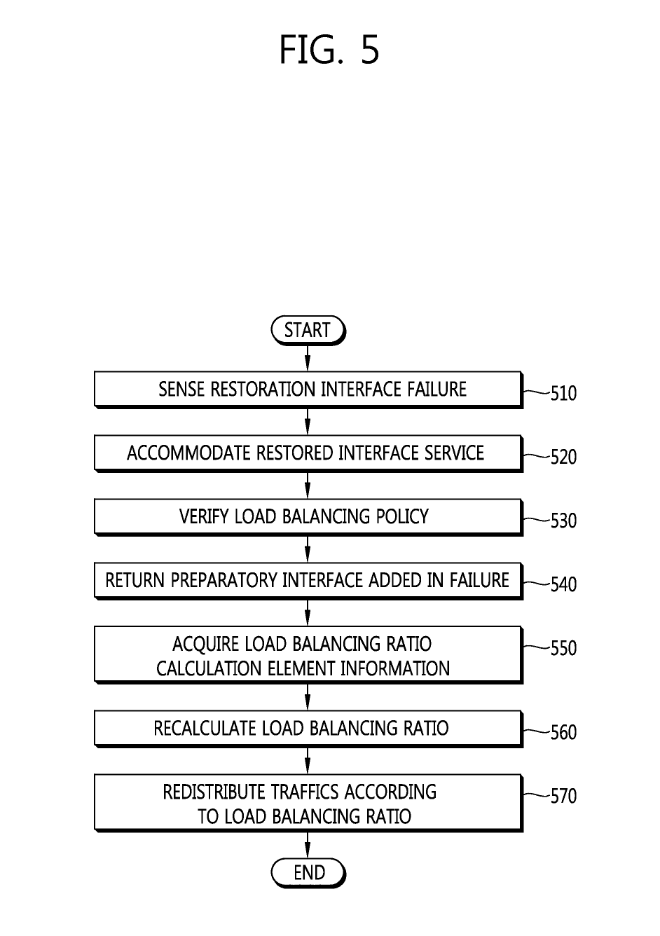

FIG. 5 is a flowchart illustrating an operation process of the system for balancing a data traffic load when the wireless interface having the failure is restored to a normal state according to the exemplary embodiment of the present invention.

Referring to FIG. 5, when the interface state management unit 240 senses a normal operation depending on restoration of the interface having the failure (510), the interface state management unit 240 notifies information on the corresponding wireless interface to the interface quality management unit 230. While the interface quality management unit 230 accommodates the service through the normally restored wireless interface (520), when the preparatory wireless interface is used when the failure occurs by verifying the load balancing policy (530), the interface quality management unit 230 restores the corresponding interface to the preparatory wireless interface again (540). Thereafter, the interface quality management unit 230 acquires from the interface state management unit 240 the load balancing ratio calculation element information for the wireless interfaces including the wireless interface which is normally restored (550), and recalculates the load balancing ratios for the wireless interfaces (560) and transfers the recalculated load balancing ratios to the interface control unit 220. The interface control unit 220 distributes the data traffics to the respective wireless interfaces according to newly set load balancing ratios (570).

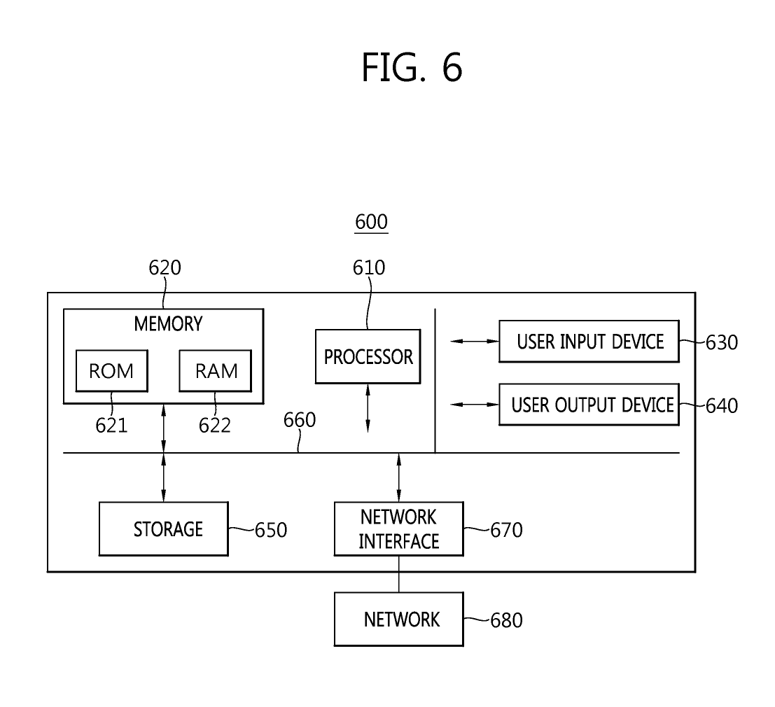

FIG. 6 is a block diagram illustrating a mobile communication apparatus according to an exemplary embodiment of the present invention.

Referring to FIG. 6, the mobile communication apparatus 600 may include at leas one processor 610, a memory 620 storing at least one program, a user input device 630, a user output device 640, and a storage 650, and the respective components may communicate with each other through a bus 660. Further, the mobile communication apparatus 600 may include a network interface 670 for connection with a network 680. Herein, the network interface 670 may be constituted by a plurality of wireless interfaces.

The processors 610 may be a central processing unit (CPU) or a semiconductor device that executes programs in the memory 620 and/or the storage 650. The memory 620 and the storage 650 may include various types of volatile or non-volatile storage media. For example, the memory 620 may include a read-only memory 621 and a random-access memory 622.

The programs monitor whether a failure occurs in a plurality of wireless interfaces included in the mobile communication apparatus 600, calculates load balancing ratios to be set for the plurality of wireless interfaces, and distributes data traffics to the plurality of respective wireless interfaces based on the calculated load balancing ratios. Herein, information on the wireless interfaces may include received signal strength information of each wireless interface, round trip time (RTT) information with a mobility integration control server for each wireless interface, bandwidth information of each wireless interface, positional information of base stations corresponding to the plurality of wireless interfaces, respectively, moving direction information of the mobile communication apparatus 600, and moving speed information of the mobile communication apparatus 600.

As one example, the programs may calculate transmission quality values of the plurality of respective wireless interfaces based on a received signal strength value of each wireless interface, an RTT value with the mobility integration control server for each wireless interface, a relative bandwidth value of each wireless interfaced to a wireless interface having a maximum bandwidth, and a movement direction value and a moving speed value of the mobile communication apparatus 600 for the corresponding base station for each wireless interface, and calculate the load balancing ratios to be set for the plurality of wireless interfaces, respectively based on the calculated transmission quality values.

Meanwhile, the programs may select a load balancing mode to be performed between a static mode in which the data traffics are distributed to the plurality of wireless interfaces, respectively according to predetermined load balancing ratios and a dynamic mode in which the data traffics are distributed to the plurality of wireless interfaces, respectively according to the load balancing ratios calculated based on the information on the operation state and manage the number of wireless interfaces used for load balancing.

Further, the programs may exclude, when a failure is sensed in at least one wireless interface among the plurality of wireless interfaces, the corresponding wireless interface from data transmission and recalculate the load balancing ratios to be set for the residual wireless interfaces, respectively, and make, when a preparatory wireless interface is present among the plurality of wireless interfaces, the corresponding preparatory wireless interface to be included at the time of recalculating the load balancing ratios, and make, when a normal operation of the wireless interface having the failure is sensed afterward, the corresponding wireless interface to be included and exclude the preparatory wireless interface.

The above description just illustratively describes the technical spirit of the present invention and various changes, modifications, and variations become apparent to those skilled in the art within a scope without departing from an essential characteristic of the present invention. Accordingly, the various embodiments disclosed herein are not intended to limit the technical spirit but describe with the true scope and spirit being indicated by the following claims. The scope of the present invention may be interpreted by the appended claims and all the technical spirits in the equivalent range thereto are intended to be embraced by the claims of the present invention.

What is claimed is:

1. A system for balancing a data traffic load, the system comprising:
an interface state management unit monitoring whether a failure occurs in a plurality of wireless interfaces included in a mobile communication apparatus;
an interface quality management unit calculating load balancing ratios to be set for the plurality of wireless interfaces respectively based on information on the plurality of wireless interfaces; and
an interface control unit distributing data traffics to the plurality of respective wireless interfaces based on the load balancing ratios.

2. The system of claim 1, wherein the information on the wireless interface includes received signal strength information of each wireless interface, round trip time (RTT) information with a mobility integration control server for each wireless interface, bandwidth information of each wireless interface, positional information of base stations corresponding to the plurality of wireless interfaces respectively, moving direction information of the mobile communication apparatus, and moving speed information of the mobile communication apparatus.

3. The system of claim 1, wherein the interface quality management unit calculates transmission quality values of the plurality of respective wireless interfaces based on a received signal strength value of each wireless interface, an RTT value with the mobility integration control server for each wireless interface, a relative bandwidth value of each wireless interfaced to a wireless interface having a maximum bandwidth, and a movement direction value and a moving speed value of the mobile communication apparatus for the corresponding base station for each wireless interface, and calculates the load balancing ratios to be set for the plurality of wireless interfaces respectively based on the calculated transmission quality values.

4. The system of claim 1, further comprising:
a load balancing policy management unit selecting a load balancing mode to be performed between a static mode in which the data traffics are distributed to the plurality of wireless interfaces, respectively according to predetermined load balancing ratios and a dynamic mode in which the data traffics are distributed to the plurality of wireless interfaces, respectively according to the load balancing ratios calculated based on the information on the operation state and managing the number of wireless interfaces used for load balancing.

5. The system of claim 1, wherein the interface quality management unit excludes, when a failure is sensed in at least one wireless interface among the plurality of wireless interfaces, the corresponding wireless interface from data transmission and recalculates the load balancing ratios to be set for the residual wireless interfaces, respectively.

6. The system of claim 5, wherein the interface quality management unit makes, when a preparatory wireless interface is present among the plurality of wireless interfaces, the corresponding preparatory wireless interface to be included at the time of recalculating the load balancing ratios.

7. The system of claim 6, wherein the interface quality management unit makes, when a normal operation of the wireless interface having the failure is sensed afterward, the corresponding wireless interface to be included and exclude the preparatory wireless interface.

8. A method for balancing a data traffic load by a system for balancing a data traffic load, the method comprising:
monitoring whether a failure occurs in a plurality of wireless interfaces included in a mobile communication apparatus;
calculating load balancing ratios to be set for the plurality of wireless interfaces, respectively based on information on the plurality of wireless interfaces; and
distributing data traffics to the plurality of respective wireless interfaces based on the load balancing ratios.

9. The method of claim 8, wherein the information on the wireless interface includes received signal strength information of each wireless interface, round trip time (RTT) information with a mobility integration control server for each wireless interface, bandwidth information of each wireless interface, positional information of base stations corresponding to the plurality of wireless interfaces respectively, moving direction information of the mobile communication apparatus, and moving speed information of the mobile communication apparatus.

10. The method of claim 9, wherein the calculating of the load balancing ratios includes,
calculating transmission quality values of the plurality of respective wireless interfaces based on a received signal strength value of each wireless interface, an RTT value with the mobility integration control server for each wireless interface, a relative bandwidth value of each wireless interfaced to a wireless interface having a maximum bandwidth, and a movement direction value and a moving speed value of the mobile communication apparatus for the corresponding base station for each wireless interface; and
calculating load balancing ratios to be set for the plurality of wireless interfaces respectively based on the transmission quality values.

11. The method of claim 8, further comprising:
before the calculating of the load balancing ratios,
verifying a load balancing mode to be performed between a static mode in which the data traffics are distributed to the plurality of wireless interfaces, respectively according to predetermined load balancing ratios and a dynamic mode in which the data traffics are distributed to the plurality of wireless interfaces, respectively according to the load balancing ratios calculated based on the information on the operation state and
verifying the number of wireless interfaces used for load balancing.

12. The method of claim 8, further comprising:
after the calculating of the load balancing ratios,
excluding, when a failure is sensed in at least one wireless interface among the plurality of wireless interfaces, the corresponding wireless interface from data transmission and recalculating the load balancing ratios to be set for the residual wireless interfaces, respectively.

13. The method of claim 12, wherein in the recalculating of the load balancing ratios, when a preparatory wireless interface is present among the plurality of wireless interfaces, the corresponding preparatory wireless interface is made to be included at the time of recalculating the load balancing ratios.

14. The method of claim 13, further comprising:
after the recalculating of the load balancing ratios,
making, when a normal operation of the wireless interface having the failure is sensed afterward, the corresponding wireless interface to be included and excluding the preparatory wireless interface.

15. A mobile communication apparatus comprising:
at least one processor; and
a memory storing at least one program,
wherein the program
is configured to be executed by the at least one processor,
monitors whether a failure occurs in a plurality of wireless interfaces included in a mobile communication apparatus,
calculates load balancing ratios to be set for the plurality of wireless interfaces, respectively based on information on the plurality of wireless interfaces; and
distributes data traffics to the plurality of respective wireless interfaces based on the load balancing ratios.

16. The mobile communication apparatus of claim 15, wherein the information on the wireless interface includes received signal strength information of each wireless interface, round trip time (RTT) information with a mobility integration control server for each wireless interface, bandwidth information of each wireless interface, positional information of base stations corresponding to the plurality of wireless interfaces, respectively, moving direction information of the mobile communication apparatus, and moving speed information of the mobile communication apparatus.

17. The mobile communication apparatus of claim 15, wherein the program calculates transmission quality values of the plurality of respective wireless interfaces based on a received signal strength value of each wireless interface, an RTT value with the mobility integration control server for each wireless interface, a relative bandwidth value of each wireless interfaced to a wireless interface having a maximum bandwidth, and a movement direction value and a moving speed value of the mobile communication apparatus for the corresponding base station for each wireless interface, and calculates the load balancing ratios to be set for the plurality of wireless interfaces, respectively based on the calculated transmission quality values.

18. The mobile communication apparatus of claim 15, wherein the program selects a load balancing mode to be performed between a static mode in which the data traffics are distributed to the plurality of wireless interfaces, respectively according to predetermined load balancing ratios and a dynamic mode in which the data traffics are distributed to the plurality of wireless interfaces, respectively according to the load balancing ratios calculated based on the information on the operation state and manages the number of wireless interfaces used for load balancing.

19. The, mobile communication apparatus of claim 15, wherein the program excludes, when a failure is sensed in at least one wireless interface among the plurality of wireless interfaces, the corresponding wireless interface from data transmission and recalculates the load balancing ratios to be set for the residual wireless interfaces, respectively.

20. The mobile communication apparatus of claim 19, wherein the program makes, when a preparatory wireless interface is present among the plurality of wireless interfaces, the corresponding preparatory wireless interface to be included at the time of recalculating the load balancing ratios, and makes, when a normal operation of the corresponding wireless interface is sensed afterward, the corresponding wireless interface to be included and excludes the preparatory wireless interface.
